(19) United States
(12) Patent Application Publication
(10) Pub. No.: US 2013/0328726 A1
(43) Pub. Date: Dec. 12, 2013

(54) OSCILLATING MOBILE DEVICE POSITION DETERMINATION

(71) Applicant: QUALCOMM INCORPORATED, San Diego, CA (US)

(72) Inventors: Wyatt Thomas RILEY, Chesterbrook, PA (US); William James MORRISON, San Francisco, CA (US); Dominic Gerard FARMER, Los Gatos, CA (US); Mark L. MOEGLEIN, Ashland, OR (US)

(73) Assignee: QUALCOMM INCORPORATED, San Diego, CA (US)

(21) Appl. No.: 13/797,651

(22) Filed: Mar. 12, 2013

Related U.S. Application Data
(60) Provisional application No. 61/657,557, filed on Jun. 8, 2012.
(60) Provisional application No. 61/670,522, filed on Jul. 11, 2012.

(51) Int. Cl. G01S 5/02

(52) U.S. Cl. CPC G01S 5/02
USPC 342/451; 342/450

(57) ABSTRACT

A method in a mobile device includes: receiving location signals at the mobile device; measuring sensor data at the mobile device; determining an oscillation rate of the mobile device from the sensor data; in response to the oscillation rate of the mobile device being undesirable, at least one of: (1) determining a desired sampling rate based on the oscillation rate, the desired sampling rate being different from the oscillation rate; and sampling the location signals at the mobile device at the desired sampling rate; (2) sampling the location signals at the mobile device at a randomized sampling rate; (3) disabling a power improvement technique; (4) increasing filtering of determined course information; (5) reducing a nominal filter bandwidth; or (6) increasing a present sampling rate of the location signals to satisfy Nyquist criteria for the oscillation rate; and determining the position associated with the mobile device using the location signals.

### CROSS-REFERENCE TO RELATED APPLICATIONS

This application claims the benefit of U.S. Provisional Application No. 61/657,557, entitled “Use of Relative Positioning Techniques to Enhance Absolute Positioning Measurement Techniques,” filed Jun. 8, 2012, and U.S. Provisional Application No. 61/670,552, entitled “Use of Relative Positioning Techniques to Enhance Absolute Positioning Measurement Techniques,” filed Jul. 11, 2012, both of which are assigned to the assignee hereof, and incorporated herein by reference.

### BACKGROUND

Pedestrians using location devices often want to know the speed and position of their body, on average, and not the speed and position of the device itself. When the device is on a user's arm, or leg, especially near or at the ends of these limbs, i.e., the user's hand or foot, the device speed can be significantly different than the user speed. For example, even with a steady user speed, the device speed could be twice as fast, or near zero, at certain points in the walk/run cycle.

Measuring the speed or position of the device at times when the device speed is significantly different than the user's speed can lead to incorrect speeds and positions for the user. This issue can be exacerbated by duty cycle based power saving techniques, e.g., sampling the device speed and/or position intermittently for a very short period. This can lead to incorrect but similar speeds being repeatedly sampled (providing additive errors and/or false readings) and/or aliasing.

In a pedestrian use case, sinusoidal variations in Global Navigation Satellite System (GNSS) Doppler measurements have been observed due to aliasing of sub-second GNSS measurement dwell executed a 1 Hz with near 1 Hz motion of the user. This causes sinusoidal variations in estimated speed, course, and position. For example, if a GNSS measurement dwell is executed for 200 ms at 1 Hz and a user is swinging a GNSS receiver in hand at 1.05 Hz, then sinusoidal speed, heading, and position variations may be observed at 1/20 Hz.

### SUMMARY

An example method in a mobile device for determining a position associated with the mobile device includes: receiving location signals at the mobile device; measuring sensor data at the mobile device; determining an oscillation rate of the mobile device from the sensor data; in response to the oscillation rate of the mobile device being undesirable, at least one of: (1) determining a desired sampling rate based on the oscillation rate, the desired sampling rate being different from the oscillation rate; and sampling the location signals at the mobile device at the desired sampling rate; (2) sampling the location signals at the mobile device at a randomized sampling rate; (3) disabling a power improvement technique; (4) increasing filtering of determined course information; (5) reducing a nominal filter bandwidth; or (6) increasing a present sampling rate of the location signals to satisfy Nyquist criteria for the oscillation rate; and determining the position associated with the mobile device using the location signals.

Implementations of such a method may include one or more of the following features. The oscillation rate is undesirable if the oscillation rate is associated with aliasing, and the desired sampling rate is faster than the oscillation rate of the mobile device. Measuring sensor data comprises measuring sensor data from at least one of an accelerometer, a magnetometer, a pedometer, a barometric pressure sensor, or a gyroscope. The oscillation rate is undesirable if the oscillation rate is indicative of pedestrian motion and is similar to the present sampling rate of the location signals. The oscillation rate is undesirable if the oscillation rate is indicative of substantially uniform pedestrian motion for longer than a threshold length of time and is similar to the present sampling rate of the location signals. The method further includes determining an oscillation magnitude of the mobile device and at least one of operations (1)-(6) are performed in response to the oscillation rate of the mobile device and the oscillation magnitude of the mobile device both being indicative of substantially uniform pedestrian motion for longer than a threshold length of time. The oscillation rate is undesirable if the oscillation rate is sufficiently similar to the present sampling rate to induce an oscillation error greater than a threshold error.

An example mobile device includes: a receiver configured to receive location signals; a sensor configured to measure sensor data; rate determining means, communicatively coupled to the sensor, for determining an oscillation rate of the mobile device from the sensor data; desirability means for determining whether the oscillation rate is undesirable; at least one of: (1) sampling rate means, communicatively coupled to the rate determining means, for determining a desired sampling rate based on the oscillation rate; and first sampling means, communicatively coupled to the sampling rate means, the desirability means, and the receiver, for sampling the location signals at the desired sampling rate in response to the desirability means determining that the oscillation rate is undesirable; (2) second sampling means, communicatively coupled to the desirability means, for sampling the location signals at a randomized sampling rate in response to the desirability means determining that the oscillation rate is undesirable; (3) disabling means, communicatively coupled to the desirability means, for disabling a power improvement technique in response to the desirability means determining that the oscillation rate is undesirable; (4) first filtering means, communicatively coupled to the desirability means, for increasing filtering of course information determined from the location signals in response to the desirability means determining that the oscillation rate is undesirable; (5) second filtering means, communicatively coupled to the desirability means, for reducing a nominal filter bandwidth in response to the desirability means determining that the oscillation rate is undesirable; (6) third sampling means, communicatively coupled to the desirability means, for increasing a present sampling rate of the location signals to satisfy Nyquist criteria for the oscillation rate in response to the desirability means determining that the oscillation rate is undesirable; and a position module configured to determine a position of the mobile device using the location signals.

Implementations of such a mobile device may include one or more of the following features. The oscillation rate is undesirable if the oscillation rate is associated with aliasing, and the desired sampling rate is faster than the oscillation rate. The sensor comprises at least one of an accelerometer, a magnetometer, a pedometer, a barometric pressure sensor, or a gyroscope. The oscillation rate is undesirable if the oscillation rate is indicative of pedestrian motion and is similar to the present sampling rate of the location signals. The oscillation rate is undesirable if the oscillation rate is indicative of substantially uniform pedestrian motion for longer than a threshold length of time and is similar to the present sampling rate of the location signals. The mobile device further includes magnitude means for determining a magnitude of oscillation of the mobile device, where at least one of the sampling rate means, first sampling means, second sampling means, third sampling means, disabling means, first filtering means, or second filtering means, are responsive to the oscillation rate and the magnitude of oscillation of the mobile device being indicative of substantially uniform pedestrian motion for longer than a threshold length of time. The oscillation rate is undesirable if the oscillation rate is sufficiently similar to the present sampling rate to induce an oscillation error greater than a threshold error.

Another example mobile device includes: a receiver configured to receive location signals; a sensor configured to measure sensor data; a processor, communicatively coupled to the sensor and the receiver, configured to: determine an oscillation rate of the mobile device from the sensor data; and respond to the oscillation rate being undesirable to at least one: (1) determine a desired sampling rate based on the oscillation rate; and cause the location signals to be sampled at the desired sampling rate; (2) cause the location signals to be sampled at a randomized sampling rate; (3) disable a power improvement technique; (4) increase filtering of course information determined from the location signals; (5) reduce a nominal filter bandwidth; (6) increase a present sampling rate of the location signals to satisfy Nyquist criteria for the oscillation rate; and determine a position of the mobile device using the location signals.

Implementations of such a mobile device may include one or more of the following features. The processor is further configured to: determine a magnitude of oscillation of the mobile device; and respond to the oscillation rate and the magnitude of oscillation of the mobile device being indicative of substantially uniform pedestrian motion for longer than a threshold length of time to perform at least one of operations (1)-(6).

An example processor-readable storage medium includes processor-readable instructions configured to cause a processor to: determine an oscillation rate of a mobile device from mobile device sensor data; and respond to the oscillation rate being undesirable to at least one: (1) determine a desired sampling rate based on the oscillation rate; and cause received location signals to be sampled at the desired sampling rate; (2) cause the location signals to be sampled at a randomized sampling rate; (3) disable a power improvement technique; (4) increase filtering of course information determined from the location signals; (5) reduce a nominal filter bandwidth; (6) increase a present sampling rate of the location signals to satisfy Nyquist criteria for the oscillation rate; and determine a position of the mobile device using the location signals.

Implementations of such a processor-readable storage medium may include one or more of the following features. The processor-readable storage medium further includes instructions configured to cause the processor to: determine a magnitude of oscillation of the mobile device; and respond to the oscillation rate and the magnitude of oscillation of the mobile device being indicative of substantially uniform pedestrian motion for longer than a threshold length of time to perform at least one of operations (1)-(6).

Items and/or techniques described herein may provide one or more of the following capabilities, as well as other capabilities not mentioned. Mobile device position determination in the presence of mobile device oscillation can be improved. Mobile device position aliasing due to mobile device oscillation, e.g., due to pedestrian motion, can be reduced. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a schematic view of a telecommunications and positioning system.

FIG. 2 is a block diagram of a mobile device shown in FIG. 1.

FIG. 3 is a functional block diagram of portions of the mobile device shown in FIG. 1.

FIG. 4 is a block flow diagram of a process of determining a position of the mobile device shown in FIG. 1.

### DETAILED DESCRIPTION

Techniques are provided for determining a position of a mobile device. For example, motion sensor data can be used to determine an oscillation rate of a mobile device. In response to the oscillation rate being near a measurement rate of location signals (e.g., satellite signals), one or more techniques may be employed to reduce the effect of the oscillation on the position determination. For example, the measurement rate or timing may be altered such that the oscillation rate differs significantly from the measurement rate.

As one example, inertial sensors can determine the primary modes of a gait cycle, as in a pedometer, and help ensure that sampling done by absolute positioning (e.g., for power savings) is not done in sync with the pedestrian's main oscillation modes. For example, if a user is striding at 1.05 Hz, then a duty-cycle based power improvement technique of a Global Navigation Satellite System (GNSS) will avoid waking up at 1 Hz to avoid significant aliasing. A power improvement schedule can either be turned off, or changed to a frequency notably different from the stride (two steps) frequency such that aliasing effects are far enough away from 0 Hz to be safely averaged with other filtering techniques. Duty-cycle based power saving techniques can operate on absolute positioning, while helping to ensure that the impact of those techniques on positioning accuracy is acceptable. As a refinement of this example, even a very low power accelerometer-only based pedometer could detect the pedometer motion, allowing GNSS dynamic power optimization (DPO) to intentionally aim to wake up at about two times, or even about 1.5 times, the current pedestrian stride frequency.

Additionally, GNSS DPO rescheduling could safely be made to occur only when the gait cycle is very uniform, as detected by a pedometer, as irregular gait cycles would already alias semi-randomly with a regular GNSS DPO wake up schedule. This would allow for sufficient sampling to allow reasonable post-measurement filtering.

As another example, short-term oscillations can be measured as relative positioning changes via inertial navigation equations. Even with large uncertainties due to initialization and/or low quality or low power sensors, this is quite achievable over sub-second periods of oscillation typical of human motion. Outputs of absolution positioning (and velocity) measurements can be adjusted based on the device-average position track, and device-average speed over an oscillation cycle, as determined by the sensors.

As used herein, a mobile device, sometimes referred to as a mobile terminal (MT), a mobile station (MS) or user equipment (UE), is a device such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term mobile device includes devices that communicate with a personal navigation device (PND), such as by short-range wireless, infrared, wireline connection, or other connection—regardless of whether satellite signal reception, assistance data reception, and/or position-related processing occurs at the device or at the PND. Also, the term mobile device includes devices, including wireless communication devices, computers, laptops, etc. that are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a mobile device.

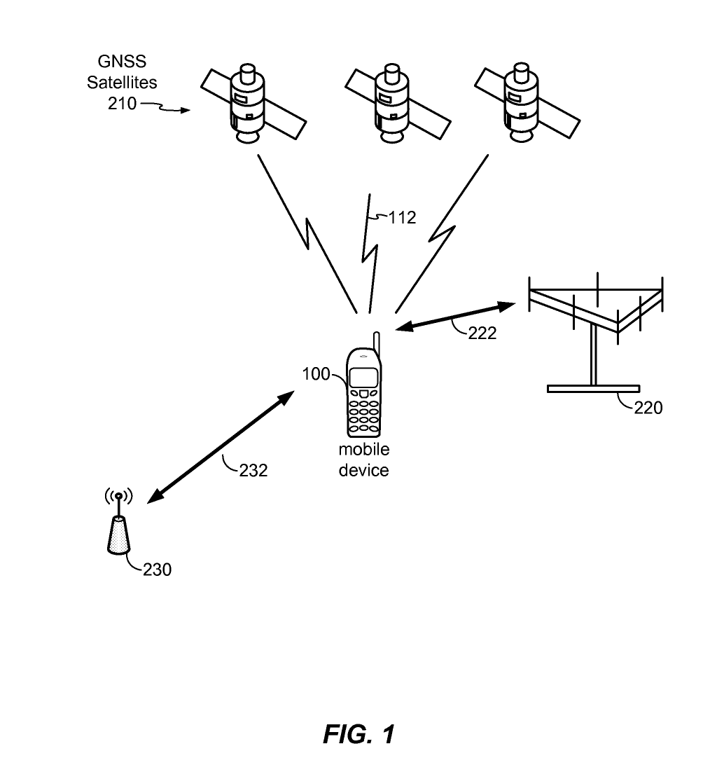

Referring to FIG. 1, a communication system 10 includes GNSS satellites 210, a base station 220, an access point 230, and a mobile device 100. The mobile device 100 is configured to receive signals from the satellites 210 via links 112. The mobile device 100 is further configured to communicate bi-directionally with the base station 220 and the access point 230 via communication links 222, 232, respectively.

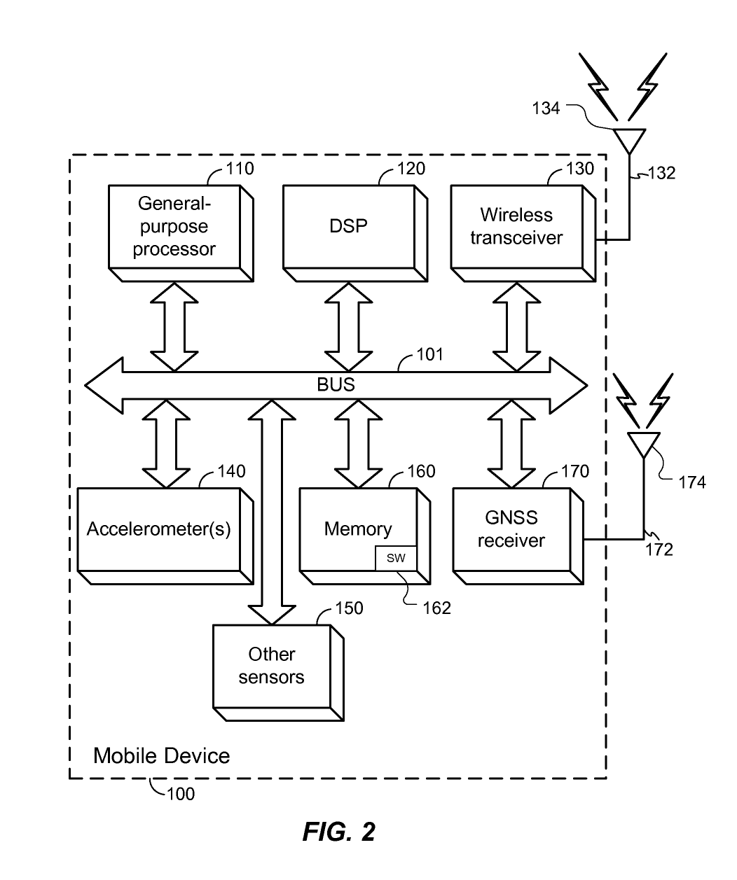

Referring also to FIG. 2, the mobile device 100 includes a computer system including a general-purpose processor 110, a digital signal processor (DSP) 120, a wireless transceiver 130, one or more accelerometers 140, other sensors 150, a non-transitory memory 160, and a GNSS receiver 170, communicatively coupled to each other by a bus 101. The wireless transceiver 130 is connected by a line 132 to an antenna 134 for sending and receiving communications to/from the base station 220 and the access point 230 shown in FIG. 1. The GNSS receiver 170 is connected by a line 172 to an antenna 174 for receiving location signals (signals from which, at least in part, location can be determined) from the satellites 210 shown in FIG. 1. The processor 110 is preferably an intelligent device, e.g., a personal computer central processing unit (CPU) such as those made by Intel® Corporation or AMD®, a microcontroller, an application specific integrated circuit (ASIC), etc. The memory 160 is a processor-readable storage medium that includes random access memory (RAM) and read-only memory (ROM). The memory 160 stores processor-readable, processor-executable software 162 code containing processor-readable instructions for controlling the processor 110 (configured to, when executed, cause the processor 110) to perform functions described herein (although the description may read that the software 162 performs the functions). Alternatively, the software 162 may not be directly executable by the processor 110 but configured to cause the processor 110, e.g., when compiled and executed, to perform the functions. The functions implement a positioning system. The software 162 can be loaded onto the memory 160 by being downloaded via a network connection, uploaded from a disk, etc. Further, the software 162 may not be directly executable, e.g., requiring compiling before execution.

The other sensors 150 are configured to measure relevant information. For example, the other sensors 150 may include a pedometer and/or a magnetometer and/or a gyroscope and/or a barometric pressure sensor and/or still other sensors. The accelerometer(s) 140 and/or one or more of the other sensors 150 is/are configured to provide information from which a period or cycle of oscillation of the mobile device 100, e.g., a gait of a user of the mobile device 100, can be determined.

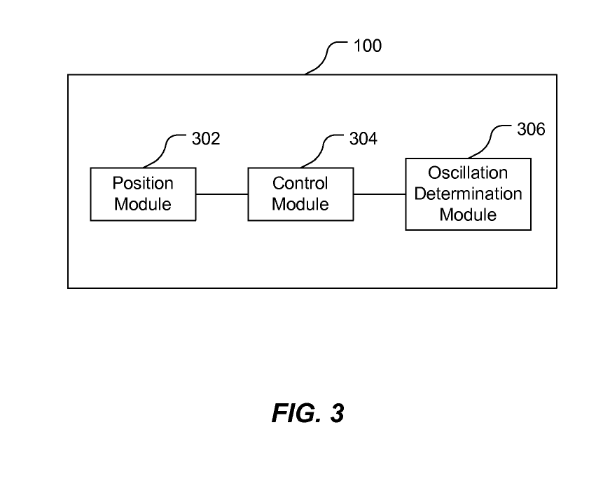

Referring also to FIG. 3, the mobile device 100 includes a position module 302 (positioning means), a control module (controlling means) 304, and an oscillation detection module (oscillation determining means) 306. The modules 302, 304, 306 are functional modules communicatively coupled to each other and implemented by the processor 110 and the software 162 stored in the memory 160. The position module is also implemented by the GNSS receiver 170 and the oscillation determination module 306 is also implemented by the accelerometer(s) 140 and/or the other sensors 150. Reference to the modules 302, 304, 306 performing or being configured to perform a function is shorthand for the processor 110 performing or being configured to perform the function in accordance with the software 162 (and/or firmware, and/or hardware of the processor 110) and, for the oscillation determination module 306, the accelerometer(s) 140 and/or the other sensors 150 as appropriate. Similarly, reference to the processor 110 performing a position determination, controlling, or oscillation determination function is equivalent to the position module 302, the control module 304, or the oscillation determination module 306, respectively, performing the function.

The position module 302 is configured to obtain and process information in order to determine a position of the mobile device 100. For example, here the position module 302 measures GNSS signals through the GNSS receiver 170 and the antenna 174. To conserve power, the position module 302 may periodically measure the GNSS signals, e.g., alternating between going to sleep and waking to take measurements and calculate a position.

The oscillation determination module 306 is configured to measure motion and process motion measurement information to determine oscillation characteristics of the mobile device 100. The oscillation determination module 306 can determine one or more characteristics of the oscillation, e.g, period or cycle time, or oscillation rate. For example, the oscillation determination module 306 includes rate determining means to determine an oscillation rate of the mobile device 100 and to report this rate to the control module 304. Inertial sensors can be used to detect cyclic motion, e.g., near-1 Hz pedestrian motion. This may be specified coarsely as the nature of the user motion. Given coarse information, the resulting beat frequency can be approximated a priori or. Given precise information, the beat frequency can be computed within a margin of error.

The control module 304 is configured to detect a condition or conditions where there is potential for undesirable effects to occur resulting from oscillation of the mobile device 100. The control module 304 includes desirability means to determine that the mobile device 100 is oscillating in a manner and at a rate that is undesirable, e.g., that may induce errors in position determination. The control module 304 analyzes oscillation characteristics reported by the oscillation determination module 306 and determines whether the mobile device 100 is experiencing substantially uniform/constant oscillation (e.g., oscillation at a rate that is ±10% of a fixed rate) that is close enough to an activation rate of the position module 302 to induce errors in positions determined by the position module 302. For example, the control module 304 can determine whether the oscillation rate of the mobile device is close enough to positioning measurements (e.g., a wake-up rate of the position module 302) to induce aliasing in the position determined by the position module 302. For example, the control module 304 can determine that there is a high likelihood of near-1 Hz pedestrian motion, and a measurement dwell of the position module 302 is executed for less than 1 second, also at a rate of 1 Hz or approximately 1 Hz, such that undesirable effects in position determination are likely.

The control module 304 is also configured to use oscillation information from the oscillation determination module 306 to calculate relative positioning changes. The control module 304 can calculate the relative positioning changes using inertial navigation equations and, from this, determine device-average position track and device-average speed over an oscillation cycle. The device-average position and speed pertain to the average over the course of the tracking epoch, correcting for biases inherent in the instantaneous device position due to the gait cycle. This information can then be provided to the position module to adjust determined positions to account for the oscillation of the mobile device 100.

The control module 304 can communicate with the position module 302 to mitigate undesired effects of oscillation of the mobile device 100. The control module 204 can determine the period/cycle or oscillation rate of undesirable oscillation of the mobile device 100 relative to a cycle/rate of positioning measurements and use this information to control the position module 302 to affect a positioning measurement rate, e.g., a sampling rate for GNSS signals from the satellites 210. Based on the gait characteristic(s), the control module 304 can take appropriate action to help reduce the possibility of mistaken conclusions by improperly processing data, e.g., mistakenly processing data as representative of overall user motion instead of user arm motion, etc. The control module 304 may be configured to implement any of the techniques discussed below. The techniques may be implemented under any conditions, or may be implemented in response to the processor 110 detecting pedestrian motion that has a stride rate near a measurement rate of the position module 302 (e.g., of the GNSS receiver 170). For example, one or more techniques may be implemented in response to an oscillation rate of the mobile device 100 being indicative of pedestrian motion, e.g., longer than a threshold time (i.e., a threshold length of time or a threshold amount of time), such as an oscillation rate of the mobile device 100 being near 1 Hz such as between about 0.8 Hz and about 1.2 Hz, and/or being substantially uniform, e.g., with gait varying no more than a threshold percentage (e.g., 10%) over a threshold time (e.g., several seconds). As another example, one or more techniques may be implemented in response to the oscillation, e.g., an oscillation rate and an oscillation magnitude, of the mobile device 100 being indicative of (substantially uniform) pedestrian motion, e.g., longer than a threshold time, such as an oscillation rate as discussed and an oscillation magnitude being above a threshold associated with pedestrian motion. The oscillation determination module may include magnitude means for determining a magnitude of oscillation of the mobile device 100.

As an example, the control module 304 can determine and command the position module 302 to have a measurement sampling rate such that measurements will be taken out of sync with mobile device oscillation. In the following description, the oscillation of the mobile device 100 is assumed to be due to a user of the mobile device 100 walking, but the description is applicable to oscillations due to other causes. The control module 304 may cause the position module 302 to take measurements at different phases in a user's gait. The control module 304 causes the position module 302 to measure location signals (e.g., GNSS signals) at a sampling rate that is different from the oscillation rate of the mobile device 100. Preferably, the sampling rate will be at least 10% different from the oscillation rate (i.e., less than about 90% of the oscillation rate or greater than about 110% of the oscillation rate). The threshold for the difference between the sampling and oscillation rate may be determined by the required accuracy and the estimated error associated with the oscillation aliasing effect. This threshold may be a simple threshold or a variable associated with required accuracy, observed user dynamics, other similar factors, or a combination of two or more of these factors. Thus, sampling at the same portion of the gait (e.g., while the user's hand is moving forward relative to the user and thus moving forward faster than the user and possibly in a different direction than the user as a whole) repeatedly is reduced. For example, the sampling rate can be chosen to be faster than the user's gait speed by some multiplier factor, e.g., twice as often as the user's gait (0.5 times the user's stride cycle), 1.5 times the user's gait, 1.7 times the user's gait, 2.3 times the user's gait, etc. To do this, the processor 110 can increase a time constant of one or more parameters governing detecting significant changes in user speed to reduce sinusoidal speed variation. Alternatively, the sampling rate can be randomized, with samples being taken at random points in a stride cycle. For example, a random number generator could be used to determine a random time within the stride cycle, e.g., with a sample time determined according to: s(n)=n*T+r(n)*T, wherein T is the oscillation (here stride) period, n is the sample number, and r is a random number between 0 and 1 inclusive. The effects of the stride may also be mathematically filtered to reduce aliasing. Further, the sampling can be a combination of a multiplier of oscillation period, and/or randomization, and/or filtering, and/or other techniques.

As another example, the processor 110 can turn off a power improvement schedule, e.g., in response to detecting undesired oscillation such as pedestrian motion. The processor 110 can detect pedestrian motion by analyzing sensor data, e.g, to detect cyclic motion associated with walking, such as cyclic up and down motion combined with linear motion, or cyclic backward and forward motion on top of linear motion. The processor 110 can respond to determining that the user is walking by turning off any reduced sampling or DPO. The processor 110 may not disable power improvement for all detected pedestrian motion.

As yet another example, the processor 110 can increase course filtering. The processor 110 can apply additional filtering on course data to reduce excess course noise/jitter. For example, a Kalman filter can be applied by the processor 110 to reduce the effects of the pedestrian motion on determined speed and direction. The Kalman filter may include states for the gait cycle, e.g., gait cycle magnitude, direction(s), and phase. These states may be informed by sensor data, at a minimum, and used to correct the instantaneous device position to a body average (device-average). The states may also be used to interpret and correct instantaneous device positions to a body-centered reference frame or a device-average reference frame.

Further, the position module 302 can adjust determined position and velocity based on information provided by the control module 304. The position module 302 can adjust determined absolute position and velocity values based on device-average position track and device-average speed over an oscillation cycle provided by the control module 304 by subtracting the estimated gait-induced offset at the time of applicability of the absolute device position and velocity.

Further still, the processor 110 can modify filtering techniques to mitigate the effects of conditions likely to induce undesirable effects to mitigate the effects on estimated speed, course, and position. How position, velocity, and/or heading is calculated and/or filtered can be changed, with or without any changes in absolute position measurement scheduling. For example, filtered quantities under consideration may be Doppler, user speed, user heading, or user position. The nominal navigation filter bandwidth can be reduced such that this bandwidth is sufficiently below the user motion-induced beat frequency identified to low-pass filter the gait cycle. The filter may also include a detector to identify significant changes in user motion and to enable a faster filter response than prescribed by the nominal filter bandwidth or absolute measurement rate, e.g., in response to higher-rate sensor input.

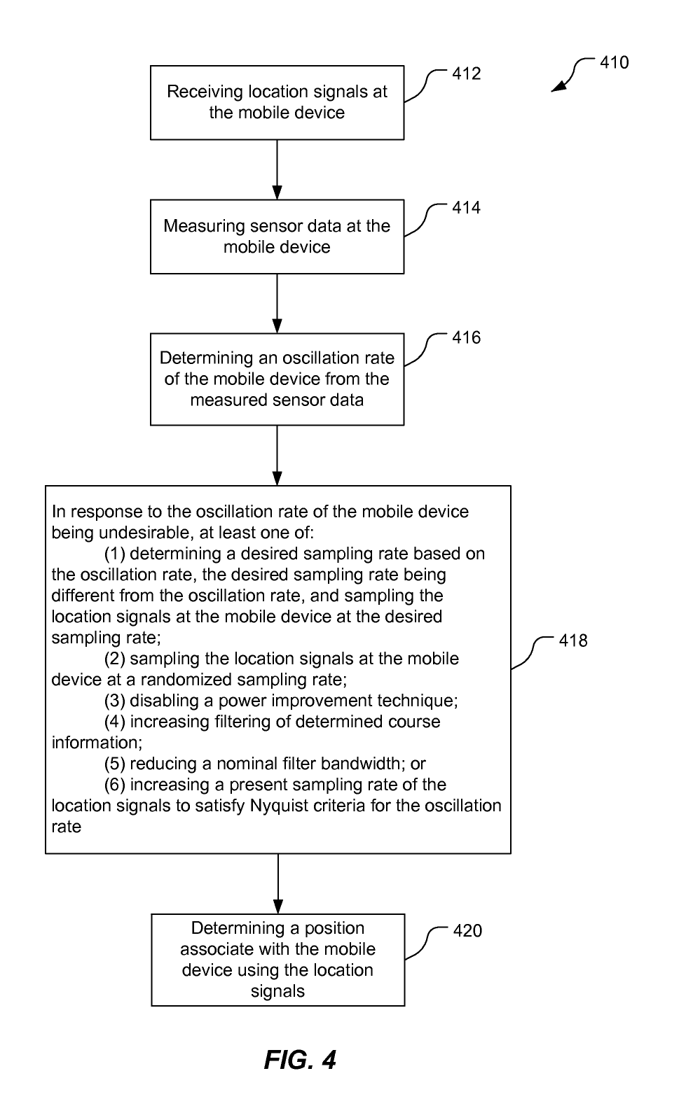

Referring to FIG. 4, with further reference to FIGS. 1-3, a process 410 of determining a position associated with the mobile device 100 includes the stages shown. The process 410 is, however, an example only and not limiting. The process 400 can be altered, e.g., by having stages added, removed, rearranged, combined, performed concurrently, and/or having single stages split into multiple stages. The position associated with the mobile device may be a position of the mobile device or a related position, e.g., a position of a user of the mobile device.

At stage 412, the process 410 includes receiving location signals at the mobile device 100. The position module 302 receives signals for use in determining a position of the mobile device 100. Here, satellite signals are received by the GNSS receiver 170.

At stage 414, the process 410 includes measuring sensor data at the mobile device 100. The oscillation determination module 306, e.g., one or more of the accelerometers 140 and/or one or more of the other sensors 150 measure data indicative of motion of the mobile device 100.

At stage 416, the process 410 includes determining an oscillation rate of the mobile device from the measured sensor data. The oscillation determination module 306 (e.g., the processor 110 using the software 162) processes the measured sensor data to determine an oscillation rate of the mobile device 100.

At stage 418, the process 410 includes, in response to the oscillation rate being undesirable, at least one of: (1) determining a desired sampling rate based on the oscillation rate, the desired sampling rate being different from the oscillation rate, and sampling the received location signals at the mobile device at the desired sampling rate; (2) sampling the location signals at the mobile device at a randomized sampling rate; (3) disabling a power improvement technique; (4) increasing filtering of determined course information; (5) reducing a nominal filter bandwidth; or (6) increasing a present sampling rate of the location signals to satisfy Nyquist criteria for the oscillation rate. That is, at least one of operations (1)-(6) are performed in response to the oscillation rate being undesirable, e.g., being associated with aliasing. The present sampling rate may be a default sampling rate, and the sampling rate may return to this default rate in response to the oscillation ceasing. The control module 304 monitors the determined oscillation rate and responds to (and is responsive to) the oscillation rate being an undesirable rate, e.g., one that is likely to induce errors in position determinations, by controlling the measuring of the location signals and/or the processing of the measured location signals to help avoid the errors that would likely be induced without such changes in the measuring and/or processing of the location signals. For example, the control module 304 may include sampling rate means and first sampling means for performing operation (1), second sampling means for performing operation (2), disabling means for performing operation (3), first filtering means for performing operation (4), second filtering means for performing operation (5), and third sampling means for performing operation (6). The oscillation rate may be determined to be undesirable, e.g., if the oscillation rate is sufficiently similar to a present sampling rage to induce an oscillation error greater than a threshold error, and/or if the oscillation rate is associated with aliasing, and/or if the oscillation rate is indicative of pedestrian motion and is similar to the present sampling rate, etc.

At stage 420, the process 410 includes determining a position of the mobile device 100 using the location signals. The position module 302 uses the location signals to determine the position of the mobile device 100 using known techniques, e.g., trilateration. The location signals used by the position module 302 may be sampled in a way to reduce position errors, or the processing by the position module 302 may be affected, according to stage 418, to help improve the accuracy of the position determined in the presence of oscillation of the mobile device 100. Multiple determined positions over time can be used to determine velocity and direction (course) of the mobile device 100.

Other Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

A wireless communication network does not have all communications transmitted wirelessly, but is configured to have at least some communications transmitted wirelessly.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method in a mobile device for determining a position associated with the mobile device, the method comprising:
receiving location signals at the mobile device;
measuring sensor data at the mobile device;
determining an oscillation rate of the mobile device from the sensor data;
in response to the oscillation rate of the mobile device being undesirable, at least one of:
(1) determining a desired sampling rate based on the oscillation rate, the desired sampling rate being different from the oscillation rate; and
sampling the location signals at the mobile device at the desired sampling rate;
(2) sampling the location signals at the mobile device at a randomized sampling rate;
(3) disabling a power improvement technique;
(4) increasing filtering of determined course information;
(5) reducing a nominal filter bandwidth; or
(6) increasing a present sampling rate of the location signals to satisfy Nyquist criteria for the oscillation rate; and
determining the position associated with the mobile device using the location signals.

2. The method of claim 1 wherein the oscillation rate is undesirable if the oscillation rate is associated with aliasing, and wherein the desired sampling rate is faster than the oscillation rate of the mobile device.

3. The method of claim 1 wherein measuring sensor data comprises measuring sensor data from at least one of an accelerometer, a magnetometer, a pedometer, a barometric pressure sensor, or a gyroscope.

4. The method of claim 1 wherein the oscillation rate is undesirable if the oscillation rate is indicative of pedestrian motion and is similar to the present sampling rate of the location signals.

5. The method of claim 1 wherein the oscillation rate is undesirable if the oscillation rate is indicative of substantially uniform pedestrian motion for longer than a threshold length of time and is similar to the present sampling rate of the location signals.

6. The method of claim 1 further comprising determining an oscillation magnitude of the mobile device and wherein at least one of operations (1)-(6) are performed in response to the oscillation rate of the mobile device and the oscillation magnitude of the mobile device both being indicative of substantially uniform pedestrian motion for longer than a threshold length of time.

7. The method of claim 1 wherein the oscillation rate is undesirable if the oscillation rate is sufficiently similar to the present sampling rate to induce an oscillation error greater than a threshold error.

8. A mobile device comprising:
a receiver configured to receive location signals;
a sensor configured to measure sensor data;
rate determining means, communicatively coupled to the sensor, for determining an oscillation rate of the mobile device from the sensor data;
desirability means for determining whether the oscillation rate is undesirable;
at least one of:
(1) sampling rate means, communicatively coupled to the rate determining means, for determining a desired sampling rate based on the oscillation rate; and
first sampling means, communicatively coupled to the sampling rate means, the desirability means, and the receiver, for sampling the location signals at the desired sampling rate in response to the desirability means determining that the oscillation rate is undesirable;
(2) second sampling means, communicatively coupled to the desirability means, for sampling the location signals at a randomized sampling rate in response to the desirability means determining that the oscillation rate is undesirable;
(3) disabling means, communicatively coupled to the desirability means, for disabling a power improvement technique in response to the desirability means determining that the oscillation rate is undesirable;
(4) first filtering means, communicatively coupled to the desirability means, for increasing filtering of course information determined from the location signals in response to the desirability means determining that the oscillation rate is undesirable;
(5) second filtering means, communicatively coupled to the desirability means, for reducing a nominal filter bandwidth in response to the desirability means determining that the oscillation rate is undesirable;
(6) third sampling means, communicatively coupled to the desirability means, for increasing a present sampling rate of the location signals to satisfy Nyquist criteria for the oscillation rate in response to the desirability means determining that the oscillation rate is undesirable; and
a position module configured to determine a position of the mobile device using the location signals.

9. The mobile device of claim 8 wherein the oscillation rate is undesirable if the oscillation rate is associated with aliasing, and wherein the desired sampling rate is faster than the oscillation rate.

10. The mobile device of claim 8 wherein the sensor comprises at least one of an accelerometer, a magnetometer, a pedometer, a barometric pressure sensor, or a gyroscope.

11. The mobile device of claim 8 wherein the oscillation rate is undesirable if the oscillation rate is indicative of pedestrian motion and is similar to the present sampling rate of the location signals.

12. The mobile device of claim 8 wherein the oscillation rate is undesirable if the oscillation rate is indicative of substantially uniform pedestrian motion for longer than a threshold length of time and is similar to the present sampling rate of the location signals.

13. The mobile device of claim 8 further comprising magnitude means for determining a magnitude of oscillation of the mobile device, wherein at least one of the sampling rate means, first sampling means, second sampling means, third sampling means, disabling means, first filtering means, or second filtering means, are responsive to the oscillation rate and the magnitude of oscillation of the mobile device being indicative of substantially uniform pedestrian motion for longer than a threshold length of time.

14. The mobile device of claim 8 wherein the oscillation rate is undesirable if the oscillation rate is sufficiently similar to the present sampling rate to induce an oscillation error greater than a threshold error.

15. A mobile device comprising:
a receiver configured to receive location signals;
a sensor configured to measure sensor data;
a processor, communicatively coupled to the sensor and the receiver, configured to:
determine an oscillation rate of the mobile device from the sensor data; and
respond to the oscillation rate being undesirable to at least one:
(1) determine a desired sampling rate based on the oscillation rate; and
cause the location signals to be sampled at the desired sampling rate;
(2) cause the location signals to be sampled at a randomized sampling rate;
(3) disable a power improvement technique;
(4) increase filtering of course information determined from the location signals;
(5) reduce a nominal filter bandwidth;
(6) increase a present sampling rate of the location signals to satisfy Nyquist criteria for the oscillation rate; and
determine a position of the mobile device using the location signals.

16. The mobile device of claim 15 wherein the oscillation rate is undesirable if the oscillation rate is associated with aliasing, and wherein the desired sampling rate is faster than the oscillation rate.

17. The mobile device of claim 15 wherein the sensor comprises at least one of an accelerometer, a magnetometer, a pedometer, a barometric pressure sensor, or a gyroscope.

18. The mobile device of claim 15 wherein the oscillation rate is undesirable if the oscillation rate is indicative of pedestrian motion and is similar to the present sampling rate of the location signals.

19. The mobile device of claim 15 wherein the oscillation rate is undesirable if the oscillation rate is indicative of substantially uniform pedestrian motion for longer than a threshold length of time and is similar to the present sampling rate of the location signals.

20. The mobile device of claim 15 wherein the processor is further configured to:
determine a magnitude of oscillation of the mobile device; and
respond to the oscillation rate and the magnitude of oscillation of the mobile device being indicative of substantially uniform pedestrian motion for longer than a threshold length of time to perform at least one of operations (1)-(6).

21. The mobile device of claim 15 wherein the oscillation rate is undesirable if the oscillation rate is sufficiently similar to the present sampling rate to induce an oscillation error greater than a threshold error.

22. A processor-readable storage medium comprising processor-readable instructions configured to cause a processor to:
determine an oscillation rate of a mobile device from mobile device sensor data; and
respond to the oscillation rate being undesirable to at least one:
(1) determine a desired sampling rate based on the oscillation rate; and
cause received location signals to be sampled at the desired sampling rate;
(2) cause the location signals to be sampled at a randomized sampling rate;
(3) disable a power improvement technique;
(4) increase filtering of course information determined from the location signals;
(5) reduce a nominal filter bandwidth;
(6) increase a present sampling rate of the location signals to satisfy Nyquist criteria for the oscillation rate; and
determine a position of the mobile device using the location signals.

23. The processor-readable storage medium of claim 22 wherein the oscillation rate is undesirable if the oscillation rate is associated with aliasing, and wherein the desired sampling rate is faster than the oscillation rate.

24. The processor-readable storage medium of claim 22 wherein the oscillation rate is undesirable if the oscillation rate is indicative of pedestrian motion and is similar to the present sampling rate of the location signals.

25. The processor-readable storage medium of claim 22 wherein the oscillation rate is undesirable if the oscillation rate is indicative of substantially uniform pedestrian motion for longer than a threshold length of time and is similar to the present sampling rate of the location signals.

26. The processor-readable storage medium of claim 22 further comprising instructions configured to cause the processor to:
determine a magnitude of oscillation of the mobile device; and
respond to the oscillation rate and the magnitude of oscillation of the mobile device being indicative of substantially uniform pedestrian motion for longer than a threshold length of time to perform at least one of operations (1)-(6).

27. The processor-readable storage medium of claim 22 wherein the oscillation rate is undesirable if the oscillation rate is sufficiently similar to the present sampling rate to induce an oscillation error greater than a threshold error.
